(19) United States
(12) Patent Application Publication
(10) Pub. No.: US 2019/0238016 A1
(43) Pub. Date: Aug. 1, 2019

(54) ROTOR FOR AN ELECTRIC MACHINE, ELECTRIC MACHINE WITH THE ROTOR AND TO METHOD FOR PRODUCING THE ROTOR

(71) Applicant: Robert Bosch GmbH

(72) Inventor: Anton Paweletz, Fellbach (DE)

(21) Appl. No.: 16/313,261

(22) PCT Filed: Jun. 20, 2017
(86) PCT No.: PCT/EP2017/065038

§ 371 Date: Dec. 26, 2018

(30) Foreign Application Priority Data
Jun. 23, 2016 (DE) 10 2016 211 251.1

(51) Int. Cl. H02K 1/30; H02K 1/02; H02K 1/27; H02K 15/03; F04D 29/18; F04D 13/06

(52) U.S. Cl. CPC H02K 1/30; H02K 1/02; H02K 1/2726; F02B 33/40; F04D 29/18; F04D 13/06; H02K 15/03

(57) ABSTRACT

The invention relates to a rotor (4) for an electric machine (1) comprising: at least one magnetic element (5) and a magnetically anisotropic sleeve (16) for receiving the at least one magnetic element (5).

### BACKGROUND OF THE INVENTION

The invention relates to a rotor for an electric machine, to an electric machine with a rotor of this kind and to a production method for producing the rotor of the electric machine.

Rotors of high-speed machines generally contain high-energy rare earth permanent magnets. High-speed machines of this kind are typically used in a speed range of more than one hundred thousand revolutions per minute.

U.S. Pat. No. 4,433,261 A discloses a synchronous machine of the permanent magnet type having a rotor. In this case, side plates composed of a nonmagnetic material, such as stainless steel, are secured on a rotor shaft by welding at a spacing such that column-shaped permanent magnets can be inserted therebetween in such a way that displacement of the permanent magnets in the circumferential direction is prevented. The magnets are adhesively bonded to the surface of the shaft and to the side plates. A resin is furthermore injected into the interspace between the magnets. The outer circumference of the magnets mounted in this way is then wound with glass fibers or carbon fibers.

### SUMMARY OF THE INVENTION

The invention discloses a rotor for an electric machine, an electric machine and a method for producing the rotor.

Accordingly, a rotor for an electric machine is provided, having: at least one magnetic element and a magnetically anisotropic sleeve, i.e. a sleeve with magnetically anisotropic properties, for receiving the at least one magnetic element.

Furthermore, an electric machine having a rotor is provided, in particular having a magnetically anisotropic rotor, wherein the electric machine has a stator, which is arranged around the rotor.

Moreover, a method for producing a rotor of this kind for an electric machine, in particular a magnetically anisotropic rotor for an electric machine, is provided, wherein the method has the following steps: providing the magnetically anisotropic sleeve and the at least one magnetic element; and inserting the at least one magnetic element into the sleeve.

The present invention provides a rotor in which leakage flux can be reduced by the magnetically anisotropic sleeve, and the main field of an electric machine fitted with the rotor can be intensified.

In one embodiment of the invention, the axis of the magnetic anisotropy of the sleeve extends in the same direction or as far as possible in the same direction as the D axis of an electric machine in which the rotor is provided.

In another embodiment of the invention, the at least one magnetic element accommodated in the sleeve is designed in such a way on its outside, in at least one section, that it forms a cavity with the inside of the sleeve, wherein the cavity is filled with air and/or a filling material, and wherein the filling material is, in particular, a nonmagnetic and preferably electrically nonconductive material. It is thereby possible to additionally reduce leakage flux.

According to one embodiment of the invention, the at least one magnetic element is a permanent magnet and, in particular, a magnetically anisotropic magnetic element. The magnetically anisotropic magnetic element can, for example, be produced from an FeNi alloy that has a magnetic anisotropy which is preferably as pronounced as possible. Equally, the magnetically anisotropic magnetic element can also be produced from an AlNiCo alloy. The AlNiCo alloy has the advantage that it has high magnetic remanence.

In another embodiment of the invention, the at least one magnetic element is a magnetic bar, a magnetic sleeve, a magnetic disk or a solid magnetic profile. Depending on whether the rotor for an electric machine is provided with a connecting rod, a magnetic disk must have a through opening for the connecting rod or not. A solid magnetic profile, which, in contrast to a magnetic bar, is dimensioned in such a way that it is too large to be arranged radially around the rotational axis of the rotor, is therefore used in electric machines without a connecting rod.

In one embodiment of the invention, the at least one magnetic element can be designed in such a way as to be magnetized radially or diametrically.

In another embodiment of the invention, the sleeve is furthermore designed with a constant inside diameter throughout, a groove or an offset to receive the at least one magnetic element. In this context, a sleeve with a constant inside diameter represents the simplest design, while a groove on the inner circumference of the sleeve in turn requires a segmented construction of the magnet arrangement.

In another embodiment of the invention, an at least partially elastic and nonmagnetic compensating element is provided on the inner circumferential surface of the sleeve, on the outer circumferential surface of the at least one magnetic element and/or at at least one end of the at least one magnetic element. The compensating element, e.g. an at least partially elastic and nonmagnetic compensating layer, can, for example, be composed of a resin, fiber composite material and/or plastic, which is at least partially still elastic after curing. In this way, the compensating element can compensate for manufacturing tolerances and furthermore has damping properties.

According to one embodiment of the invention, a nonmagnetic support plate is provided in the sleeve at one or both ends of the at least one magnetic element. Here, the nonmagnetic support plate forms an axial receptacle for the at least one magnetic element, for example.

In another embodiment of the invention, the sleeve can be connected at least to one end of a shaft part of the electric machine, e.g. by shrink-fitting or press-fitting onto the shaft part. It is thereby possible to provide a means of securing the sleeve and thus the rotor, optionally even without an additional connecting rod.

According to one embodiment of the invention, the sleeve and/or the at least one magnetic element is/are treated by a chemical process and/or a thermal process to increase the magnetic anisotropy, at least in one section, e.g. in the vicinity of a magnetic pole.

### BRIEF DESCRIPTION OF THE DRAWINGS

Further features and advantages of the present invention are explained below with reference to the figures, in which:

FIG. 1 shows a schematic sectional view from the side of an electric machine having one illustrative embodiment of a rotor according to the invention;

FIG. 2 shows a schematic sectional view through the active region of the rotor of the electric machine shown in FIG. 1;

FIG. 3 shows a schematic sectional view from the side of an electric machine having another illustrative embodiment of a rotor according to the invention;

FIG. 4 shows a schematic sectional view through the active region of the rotor of the electric machine shown in FIG. 3; and

FIG. 5 shows a flow diagram relating to the production of the rotor of the electric machine shown in FIGS. 1 to 4.

### DETAILED DESCRIPTION

The present invention relates to the structure and the design of a rotor of an electric, permanently excited machine, in particular a high-speed machine. The rotors of such electric machines generally contain high-energy permanent magnets composed of rare earths. Machines of this kind are typically used in a speed range of more than one hundred thousand revolutions per minute.

The main problem in the design of electric machines of this kind is the superposition of various extreme material stresses. Among material stresses of this kind are mechanical, dynamic, thermal and electromagnetic stresses, especially in the region of the rotor.

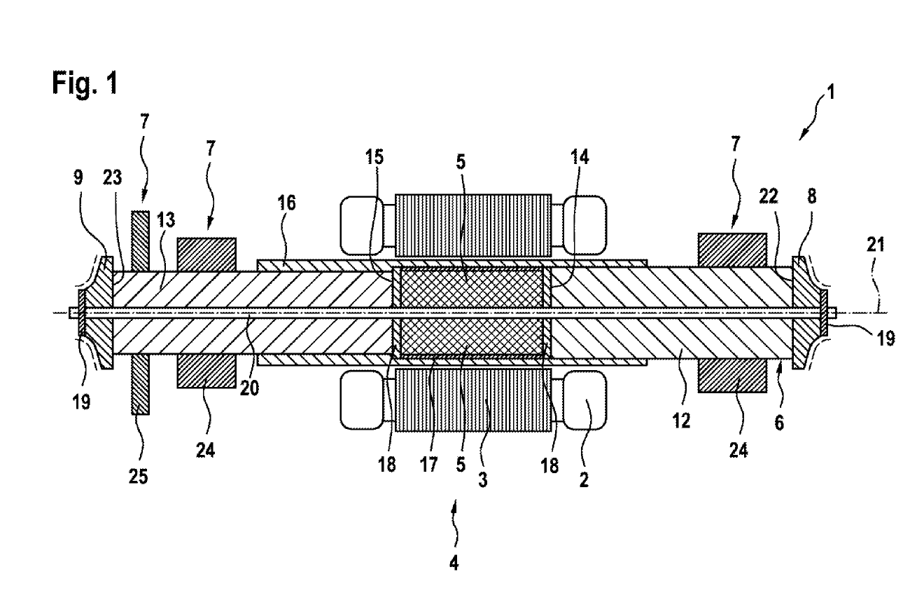

According to one embodiment of the invention, an electric machine excited by a permanent magnet and having bearings on both sides or a central motor arrangement is provided, in which one or more magnetic elements in the form of permanent magnets are arranged in the active region of the stator, as shown below in FIG. 1. Here, the respective magnetic element can be magnetized radially or diametrically.

In this case, the design of the electric machine as illustrated in FIG. 1 below has a two-part motor shaft, at least one magnetically anisotropic magnetic element and a magnetically anisotropic sleeve over the two shaft parts of the motor shaft. The sleeve is connected to both shaft parts of the motor shaft, e.g. by press-fitting or thermal shrinkage etc., as explained below.

FIG. 1 shows an example of a basic arrangement of an electric machine 1, e.g. of a high-speed machine, having a rotor 4 according to one embodiment of the invention, which is explained below.

Here, FIG. 1 first of all shows the basic arrangement of the electromagnetic active components of the illustrative electric machine 1, such as the stator 2 with windings 3, the rotor 4 according to the invention with the one or more magnetic elements 5, the shaft 6 and the bearing elements 7 of the rotor 4. Here, the illustration in FIG. 1 is purely schematic, highly simplified and not to scale. In this case, the rotor 1 according to the invention has the abovementioned magnetically anisotropic sleeve 16 for accommodating the one or more magnetically anisotropic magnetic elements 5, which are explained below. In the illustrative embodiment in FIG. 1, two magnetically anisotropic magnetic elements 5 are provided, for example, which are arranged one behind the other in the axial direction in the form of sleeves. However, the rotor 4 can also have just one magnetically anisotropic magnetic element or more than two magnetically anisotropic magnetic elements, which are arranged in the likewise magnetically anisotropic sleeve 16.

In the illustrative embodiment shown in FIG. 1, the machine 1 with the rotor 4 according to the invention forms the drive of a two-stage supercharger or compressor, for example. However, the rotor according to the invention is not restricted either to high-speed machines, superchargers or compressors or to the specific embodiment of the electric machine as illustrated in FIG. 1 but can be employed in any electric machine suitable for being equipped with the rotor 4 according to the invention, including a motor or generator.

The impellers 8 and 9 of the two compressor stages of the electric machine 1 are arranged on opposite sides of the motor in FIG. 1. The counterparts thereof, the housings or volutes, are indicated by a dashed line in FIG. 1.

As shown in FIG. 1, the rotor 4 according to the invention of the electric machine 1 has the abovementioned two-part shaft 6 or two-part motor shaft with the first shaft part 12 and the second shaft part 13. In the illustrative embodiment shown in FIG. 1, both the first and the second shaft part 12 and 13 are additionally arranged on a common connecting rod 20 composed of a nonmagnetic material, e.g. a carbon fiber composite material or steel etc. In this case, the longitudinal axis of the connecting rod 20 simultaneously also forms the longitudinal and rotational axis 21 of the shaft 6 and of the shaft parts 12, 13 thereof and of the rotor 4 arranged therebetween. In the illustrative embodiment shown in FIG. 1, the impeller 8 or 9 is arranged at the respective outer end 22, 23 of the first and the second shaft part 12 and 13, respectively.

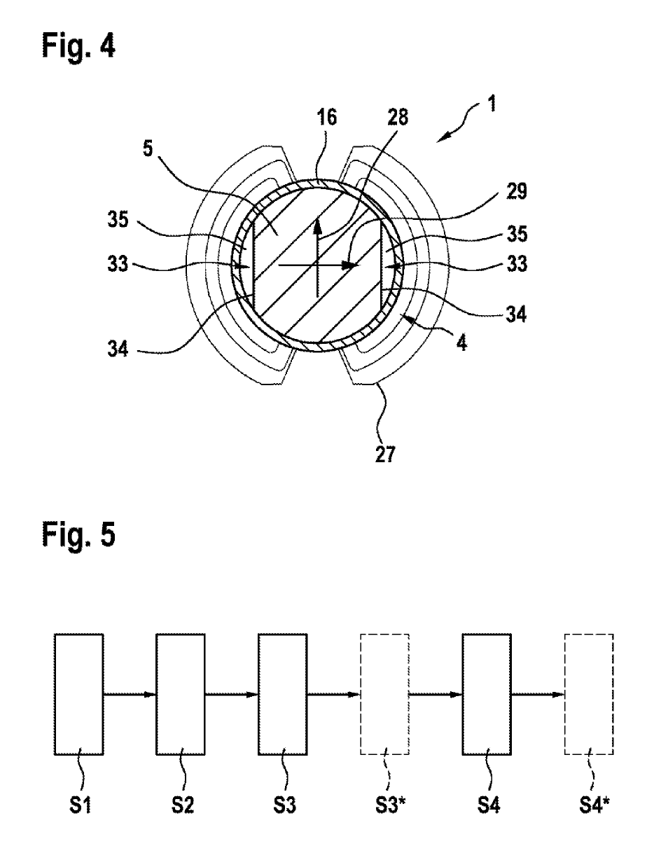

In further illustrative embodiments of the invention, as shown in the following FIGS. 3 and 4, it is also possible for a connecting rod 20 of the kind shown in FIG. 1 to be omitted. Instead, the two shaft parts 12 and 13 and the at least one magnetically anisotropic magnetic element 5 of the rotor 4 which is arranged therebetween are connected to one another in a fixed manner at least via the magnetically anisotropic sleeve 16.

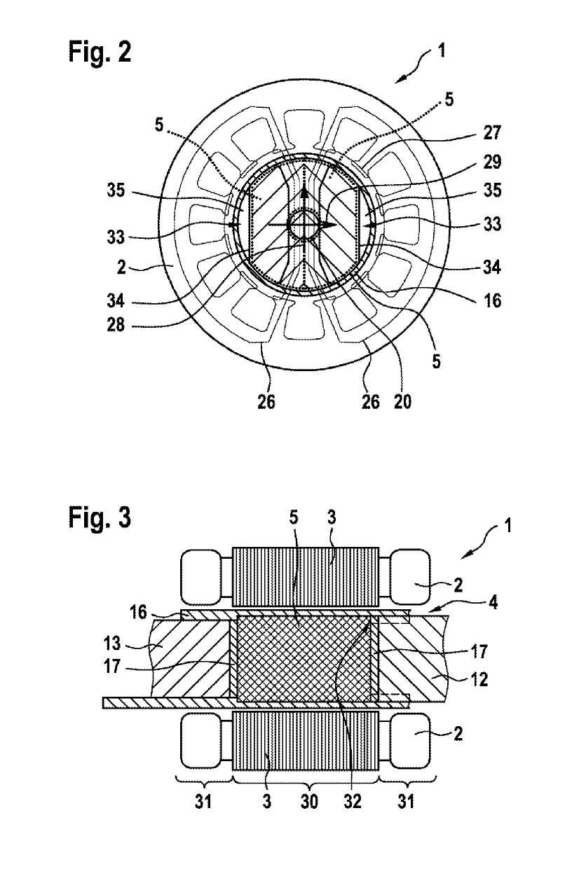

To form the rotor 4 according to the invention for an electric machine 1, the abovementioned one or more magnetic elements 5 are arranged radially around the longitudinal axis 21 of the rotor 4, between the two inner ends 14, 15 of the shaft parts 12 and 13. In the illustrative embodiment in FIG. 1, the magnetic elements 5 are arranged in corresponding fashion around the connecting rod 20 and the longitudinal axis thereof. For example, one or more magnetic elements 5 can be arranged radially as bars or magnetic bars around the rotational axis 21 of the rotor 4, as indicated in FIG. 2, around the connecting rod 20. In addition or as an alternative, one or more magnetic elements 5 in the form of magnetic sleeves or magnetic disks can also be arranged in series in the axial direction on the rotational axis 21 of the rotor 4 or of the connecting rod 20, as in FIG. 1. Here, as will be described in greater detail below, the magnetic elements 5 of the rotor 4 according to the invention are magnetically anisotropic permanent magnets, e.g. magnetically anisotropic permanent magnets composed of rare earths and, in particular, magnetically anisotropic permanent magnets composed of a suitable AlNiCo alloy.

Furthermore, the rotor 4 according to the invention has the rotor connecting sleeve or sleeve 16, e.g. a cylindrical sleeve, which extends at least over a respective section of the inner ends 14, 15 of the first and the second shaft part 12 and 13 and over the one or more magnetic elements 5 arranged therebetween. Here, the sleeve 16 serves as a radial receptacle for the respective magnetic element 5 and, as likewise described in greater detail below, is magnetically anisotropic.

In this arrangement, the sleeve 16 is connected in a fixed manner at least to the two inner ends 14, 15 or end sections of the shaft parts 12 and 13 of the shaft 6 in FIG. 1. For this purpose, the sleeve 16 is press-fitted or secured by means of thermal shrinkage on the respective inner end 14, 15 or on the inner end section of the first and the second shaft part 12 and 13. However, the invention is not restricted to the stated examples for securing the sleeve 16 on the shaft parts 12 and 13. Any form of securing means that is suitable for securing the sleeve 16 on the respective shaft part 12 of 13 can be provided. This applies to all embodiments of the invention, including the illustrative embodiments shown in the following FIGS. 2 to 4.

The stator 2 with its stator windings 3 is arranged around the outside of the sleeve 16.

As an optional addition, as shown in the illustrative embodiment in FIG. 1, an elastic compensating element 17 can be provided between the inside of the sleeve 16 and the outside of the magnetic element or elements 5, wherein the elastic compensating element 17 is nonmagnetic and preferably not electrically conductive. The elastic compensating element 17 is, for example, at least one elastic compensating or connecting layer which is nonmagnetic and preferably not electrically conductive. As a material for the elastic compensating element 17, it is possible to use a resin, for example, wherein the resin, as a nonmagnetic and electrically nonconductive material, is at least partially elastic in the cured state. However, the invention is not restricted to resin as an elastic material for the compensating element 17. Any other elastic material or any other elastic material combination can be provided which is not magmatic and preferably not electrically conductive and is suitable for connecting the respective magnetic elements 5 and the sleeve 16 of the electric machine 1.

The elastic compensating or connecting layer, which is nonmagnetic and preferably not electrically conductive, has elastic and damping properties. Furthermore, the non-elastic compensating or connecting layer, as a mechanical compensating or connecting layer, ensures uniform force equalization or uniform distribution of the preloading force of the sleeve 16 on the magnetic elements 5 in the radial direction in order to absorb the centrifugal forces produced by the magnetic elements 5 during the rotation of the shaft 6. During assembly, the elastic compensating or connecting layer can be applied in a semiliquid state to the inside of the sleeve 16 and/or the outside of the magnetic elements 5, for example, and can be heat-treated after the press-fitting of the sleeve 16, for example, in order to cure it. Here, the re-softening temperature of the material of the compensating or connecting layer is sufficiently high and, in particular, sufficiently higher than the maximum operating temperature of the magnetic elements 5 and of the sleeve 16 to ensure that the compensating or connecting layer does not accidentally soften during the operation of the electric machine 1. The provision of the elastic compensating or connecting layer has the advantage that it also allows tolerance compensation between the high-tolerance metallic elements, in this case particularly the shaft parts 12 and 13 and the sleeve 16, and the magnetic elements 5, during the manufacture of which either precise tolerances are not possible or the subsequent processes, e.g. grinding etc., are very expensive or, in some circumstances, even injurious to health. The centrifugal forces of the magnetic elements 5 can be neutralized or suitably compensated by the elastic compensating element 17, e.g. the elastic compensating or connecting layer shown in FIG. 1, within a wide operating range of rotational speed and temperature. Between the outside of the respective magnetic element 5 and the inside of the sleeve 16, the elastic compensating element 17 is preferably only as thick as is required to enable it, as has been described, to compensate manufacturing tolerances and any difference in thermal expansion and any irregularities in the magnetic elements 5, while avoiding the formation of an excessively large gap between the outside of the respective magnetic element 5 and the inside of the sleeve 16, which would impair the magnetic flux in the direction of the Q axis.

Furthermore, as an optional addition, a support plate 18 is provided as a contact washer between the respective inner ends 14, 15 of the shaft part 12 and 13 and the opposite ends of the magnetic elements 5. Here, the support plates 18 are slipped onto the connecting rod 20 shown in FIG. 1. As explained above, it is also possible for a connecting rod 20 of this kind to be omitted in other embodiments of the invention. In this case, a respective support plate 18 does not require an additional through opening to pass the connecting rod through.

The support plates 18 at the two ends of the magnetic elements 5 serve as axial receptacles for the magnetic elements 5. The support plates 18 in the form of contact washers are likewise composed of a nonmagnetic material, e.g. a carbon fiber composite material or steel etc. As an optional addition, the above-described elastic compensating element 17, in particular the elastic compensating or connecting layer, e.g. a suitable resin, can be provided between at least one of the support plates 18 and the associated shaft part 12 or 13 and/or between at least one of the support plates 18 and the end of the associated magnetic element or elements 5. In this case, the elastic compensating element 17, e.g. the elastic compensating or connecting layer, is nonmagnetic and preferably not electrically conductive, as likewise already explained above.

In the case of a segmented construction of the magnetic elements 5, in which at least one or two magnetic elements 5, e.g. in the form of magnetic bars, are arranged radially around the longitudinal axis of the rotor 4 or an outer circumferential section of the optionally present connecting rod 20, for example, the sleeve 16 can be designed with an encircling depression (not shown), e.g. groove, on its inner circumference, for example. In this case, the individual magnetic bars are first of all introduced into the sleeve 16 and into the depression, e.g. groove. Here, the inner circumferential surfaces of the magnetic elements 5 form a through opening, through which the connecting rod 20 can subsequently be passed. As an additional option, it is possible in this case for the depression, e.g. groove, to be provided with the elastic compensating element 17 on its inner circumferential surface, and/or for the magnetic elements 5 to be provided with said elastic compensating element on their outer circumferential surface. In the case of the depression, e.g. groove, the support plates 18 at the two ends of the magnetic elements 5 are likewise of segmented design to enable them to be inserted into the depression, e.g. groove, at the two ends of the magnetic elements 5.

In an alternative embodiment, it is also possible for only the magnetic elements to be accommodated in the depression, e.g. groove, without the support plates 18, or, in the case of two support plates, for just one support plate to be accommodated in the depression, e.g. groove. In this case, the support plate 18 which is not accommodated in the depression, e.g. groove, can instead also be of disk-shaped design and have an outside diameter which is matched to the inside diameter of the sleeve 16, thus enabling the support plate 18 to be inserted into the sleeve 16 and positioned at the associated end of the magnetic elements 5, outside the depression, e.g. groove.

In the case of at least one sleeve-shaped or disk-shaped magnetic element 5, as in FIG. 1, it is possible, for the insertion of the magnetic element 5 into the sleeve 16, for the sleeve 16 to be designed, at least on an insertion side, with an inside diameter which is matched in such a way to the outside diameter of the sleeve-shaped or disk-shaped magnetic element 5 that the magnetic element 5 can be inserted into the sleeve 16. In this case, the sleeve 16 can either form a constant inside diameter or be formed on the inside with an offset up to which the magnetic element 5 can be inserted, as in FIG. 1 and the following FIG. 4. Here, the optional elastic compensating element 17 on the inner circumferential surface of the sleeve 16 and/or on the outer circumferential surface of the magnetic element 5 can be provided within the sleeve 16, at least in the region of the end position of the magnetic element 5. In addition or as an alternative, it is furthermore also possible for the elastic compensating element 17 to be provided between the inner end of at least one of the shaft parts 12 and 13 and the opposite end(s) of the magnetic element or magnetic elements 5. If a support plate 18 is provided between the inner end of at least one of the shaft parts 12 and 13 and the opposite end(s) of the magnetic element 5 or magnitude elements 5, the elastic compensating element 17 can be provided between the inner end of the shaft part 12 or 13 and the support plate 18 and/or between the support plate 18 and the opposite end(s) of the magnetic element 5 or magnetic elements 5.

As is furthermore illustrated in FIG. 1, clamping elements 19, for example, are provided in the electric machine 1 in order to clamp the shaft parts 12 and 13 and the magnetic elements 5 arranged therebetween and the support plate 18 of the rotor to one another in the axial direction. Here, in the illustrative embodiment shown in FIG. 1, the clamping elements 19 are arranged and can be adjusted on the connecting rod 20 at the two outer ends of the impellers 8, 9, for example, in order to set a suitable preload. Clamping washers, for example, or any other suitable clamping elements can be provided as clamping elements 19. If no such connecting rod 20 is provided, the shaft parts 12 and 13 and the rotor 4 arranged therebetween are connected to one another at least by the sleeve 16, for example, as described above. Furthermore, additional or different connecting means, connecting methods, combinations of connecting means and/or combinations of connecting methods that are suitable for connecting the two shaft parts 12, 13 and the rotor 4 arranged therebetween can be provided. This applies to all the embodiments of the invention.

The axial support plates 18 are arranged in such a way at the ends of the magnetic elements 5 that a mechanical preload correspondingly generated and directed in the axial direction, which ensures the acceptance and radial positioning of the magnetic elements 5, can be provided by the clamping elements 19 in FIG. 1.

The axial support plates 18, which are designed primarily to retain and position the magnetic elements 5, furthermore have the advantage that, since they are produced from a nonmagnetic material or a nonmagnetic material combination, they additionally absorb some of the leakage flux at the two edges of the magnetic elements 5. As a result, the fast-rotating magnetic fields do not enter the nearby stationary construction elements of the electric machine 1. This reduces additional losses and the heating of the electric machine 1. The support plates 18 can be produced, for example, from a nonmagnetic material or a nonmagnetic material combination, e.g. from a carbon fiber composite material, steel or some other nonmagnetic metal or nonmagnetic metal alloy etc.

The shaft 6 is supported by means of radial bearings 24, which are each arranged on one of the shaft parts 12, 13.

Furthermore, an axial bearing 25 is provided on one shaft part, e.g. the second shaft part 13 in FIG. 1. In this case, the rotating disk of the axial bearing 25 is illustrated in FIG. 1. The axial bearing 25 is, for example, a conventional gas bearing, e.g. a dynamic gas bearing. However, the invention is not restricted to a conventional gas bearing as an axial bearing. In principle, any axial bearing which is suitable for supporting the shaft part of the electric machine 1 can be used.

The two impellers 8, 9 are connected in a fixed manner to the connecting rod 20 of the electric machine and the rotor 4 by the clamping elements 19, as described above.

The fit between the connecting rod 20 and the shaft parts 12, 13 can be chosen in such a way that a relative movement between the connecting rod 20 and the shaft parts 12, 13 or a sliding fit of the shaft parts 12, 13 on the connecting rod 20 is preferably possible over the entire temperature range or operating temperature range.

The connecting rod 20 is composed of a nonmagnetic material with a good or maximum possible mechanical stability and strength and preferably has a thermal expansion coefficient which is as low as possible. As described above, the connecting rod 20 can be produced from or can at least comprise a carbon fiber material, some other suitable fiber composite material or some other suitable metal, including a suitable metal alloy, for example. However, the invention is not restricted to a fiber composite material or carbon fiber material etc. for the production of the connecting rod 20. Any other nonmagnetic material or nonmagnetic material combination can be used for the connecting rod 20, including a suitable nonmagnetic metal or a nonmagnetic metal alloy which expands as little as possible when subject to heat and has a maximum possible mechanical strength and stability.

FIG. 2 shows a sectional view through the rotor 4 according to the invention shown in FIG. 1 with its two magnetic elements 5 and the sleeve 16. Here, the connecting rod 20 is indicated by a dashed line and can also be omitted, as described above. Here, the sectional illustration in FIG. 2 shows a section of the rotor structure through the active region thereof, i.e. the region of the sleeve in which the two magnetic elements 5 are arranged. The main field lines 26 and leakage field lines 27 which occur are shown here and also in the subsequent FIG. 3.

According to the invention, the rotor 4 for the electric machine 1 is of anisotropic or magnetically anisotropic design. Here, the magnetic anisotropy of the rotor 4 consists of a material anisotropy and/or a structural anisotropy, for example. The structural anisotropy is also referred to as crystal anisotropy. The effective geometrical and magnetic air gaps of the electric machine 1 are smaller as a result. In this case, the leakage fluxes are also reduced, and the main field of the electric machine 1 is intensified.

As measures for this purpose, the sleeve 16 is formed from a magnetically anisotropic material, as shown in FIG. 2, and serves as a guard ring for the respective magnetically anisotropic magnetic element 5 accommodated in the sleeve 16.

Here, two magnetic elements 5 in the form of magnetic element sleeves are arranged in series in the axial direction in the sleeve 16, for example, wherein the section in FIG. 2 in this case passes through one of said magnetic sleeves 5. As already described above with reference to FIG. 1, the one or more magnetic elements 5 in the form of magnetic sleeves or magnetic disks can be arranged in series in the axial direction on the longitudinal axis 21 of the rotor 4 or, where present, the connecting rod 20.

In an alternative embodiment, as shown by a dotted line in FIG. 2, it is possible, for example, for two magnetic elements 5, e.g. in the form of two magnetic bars, to be arranged radially around the longitudinal axis 21 of the rotor 4 or, in FIGS. 1 and 2, around the connecting rod 20 in the sleeve 16. Here, the two magnetic bars are aligned with the N-S (north pole-south pole) axis of the electric machine 1, as indicated in FIG. 2, of the electric machine 1. This N-S axis is also referred to as the D axis 28 of the electric machine 1.

If a continuous connecting rod 20 is not provided, it is also possible, in another alternative embodiment, for magnetically anisotropic solid magnetic profiles to be provided, which do not require an additional through opening to pass a connecting rod through. Here, the solid magnetic profiles can be designed, for example, as magnetic disks without a through opening etc., as indicated in FIGS. 3 and 4 below.

As described above, the nonmagnetic connecting rod 20, indicated by a dashed line in FIG. 2, of an electric machine 1 having the rotor 4 according to the invention is not necessarily designed as a continuous connecting rod 20 extending through the sleeve 16; it can also be of discontinuous design or in the form of two connecting rod pieces, each of which is connected to the associated shaft piece. Instead, it is also possible here, for example, for a connection between the two shaft parts of the two-part shaft 6 of the electric machine 1 to be made by means of the sleeve 16 without the continuous connecting rod 20 and/or by means of any other suitable connecting element, any other suitable combination of connecting elements, any other suitable connecting method and/or any other suitable combination of connecting methods etc.

The direction of the anisotropy axis of the magnetically anisotropic sleeve 16 coincides with or as far as possible with the N-S (north pole-south pole) axis of the electric machine 1, for example. As described above, this N-S axis is also referred to as the D axis 28 of the electric machine 1. The “Q axis” 29 of the electric machine 1 extends perpendicularly to the N-S axis or D axis 28, as shown in FIG. 2.

To reduce the leakage field, which is indicated by leakage field lines 27 next to the main field lines 26 in FIG. 2, at least one cavity 33 is produced on both sides of the magnetic sleeve, between the inside of the sleeve 16 and the outside of the magnetic sleeve, as the magnetic element 5, accommodated in the sleeve 16. For example, the magnetic element 5 accommodated in the sleeve 16 is designed in such a way on its outside, at least in one section, that said cavity 33 is formed between the outside of the magnetic element 5 and the inside of the sleeve 16, wherein the respective cavity 33 preferably lies on the Q axis 29 of the electric machine 1. The at least one section on the outside of the magnetic element 5 is provided, for example, with a depression and/or a flat 34 etc.

In the illustrative embodiment shown in FIG. 2, a section of the outside of the magnetic element 5 accommodated in the sleeve 16 is flattened for this purpose, for example, giving rise to a cavity 33 between the flattened side or flat 34 of the magnetic element 5 and the inside of the sleeve 16.

Instead of a magnetic sleeve, it is likewise possible, for example, for the two magnetic bars indicated by a dotted line in FIG. 2 to be provided as the magnetic element. The magnetic bars are also each provided on the outside thereof with a flat, which forms the cavity, wherein the two cavities of the magnetic bars lie, in particular, on the Q axis 29, as in the case of the magnetic sleeve. As described above with reference to FIG. 1, magnetic bars of this kind are used when the sleeve has a groove as a receptacle for the magnetic elements 5 and therefore the magnetic elements 5 have to be of segmented design to enable them to be inserted into the receptacle of the sleeve.

The cavities 33 between the two magnetic elements 5, e.g. magnetic sleeves in FIGS. 1 and 2, and the sleeve 16 can be at least partially or completely filled with air and/or optionally with a filling material 35 in addition. Here, the filling material 35 is nonmagnetic and preferably additionally elastic. As a particular preference, the filling material is furthermore thermally conductive.

Here, it is possible, in principle, to use the same material, e.g. a resin, as a filling material 35 as for the elastic compensating and connecting layer described above with reference to FIG. 1, or to use some other material, e.g. a fiber composite material, such as a carbon fiber composite material, plastic etc. At the same time, the invention is not restricted to a filling material 35 in the form of resin, plastic or a fiber composite material as a nonmagnetic material for filling the respective cavity. Any other nonmagnetic material or any other nonmagnetic material combination which is suitable for the electric machine 1 and for the partial or complete filling of the corresponding cavity 33 between the respective magnetic element 5 and the sleeve 16 of the electric machine 1 can be provided as the filling material 35.

The sleeve 16, as a guard ring, can be formed, as described above with reference to FIG. 1, from an AlNiCo alloy or an iron-nickel (Fe—Ni) alloy with magnetic anisotropy, preferably a magnetic anisotropy which is as pronounced as possible.

The regions of the sleeve 16, e.g. in the vicinity of the magnet poles, i.e. of the north pole (N) and of the south pole (S) can optionally be treated chemically and/or thermally in a separate additional process in order to increase the magnetic anisotropy in this region of the sleeve 16.

In a preferred embodiment, the sleeve 16 can be produced from a magnetic material, such as the abovementioned aluminum-nickel-cobalt alloy or AlNiCo alloy for short. A magnetic material composed of an AlNiCo alloy of this kind has a high magnetic remanence, comparable to that of rare earth magnets, and has a high magnetic stability in relation to temperature influences. Furthermore, usage temperatures of up to 500° C. are possible. This is important because of the relatively high local eddy current losses in the sleeve 16 directly during the use of the rotor within the stator.

The magnetically anisotropic magnetic elements 5 are metallic permanent magnets, based on an AlNiCo alloy, for example. Here, the material composition of the AlNiCo alloy comprises or is composed of aluminum (Al), nickel (Ni), cobalt (Co) as well as iron (Fe), copper (Cu) and titanium (Ti).

The magnetic anisotropy of rare earth magnets is generally due to the manufacturing process, especially in the case of sintered magnets.

As shown in FIG. 2, both magnetic axes, i.e. the abovementioned D axis and Q axis of the respective magnetically anisotropic magnetic element 5 and the D axis and Q axis of the magnetically anisotropic sleeve 16, in particular cylindrical sleeve, are at least as far as possible identical or, preferably, identical in the case of the rotor 4 according to the invention and the rotor construction thereof. The sleeve 16 can be manufactured from a magnetically anisotropic material. In the case after the assembly of the electric machine 1, the magnetic anisotropy of the sleeve 16 preferably extends in the direction of the D axis of the electric machine 1.

The rotor 4 according to the invention and accordingly the electric machine 1 having the rotor construction according to the invention can be produced as explained below by means of two examples. However, the invention is not restricted to these examples for the production of the rotor and the electric machine having the rotor. Any other method or combination of methods which is suitable for the production of the rotor according to the invention and of the electric machine having the rotor according to the invention can be provided.

According to the first example, the sleeve 16 is produced from a magnetically anisotropic material, e.g. a magnetic material composed of an AlNiCo alloy, e.g. an AlNiCo alloy with a material composition composed of or at least comprising aluminum (Al), nickel (Ni) and cobalt (Co) as well as iron (Fe), copper (Cu) and titanium (Ti). However, the invention is not restricted either to an AlNiCo alloy or to the stated material composition of the AlNiCo alloy as the magnetically anisotropic material. Any anisotropic material which is suitable for production of the sleeve 16 of the rotor of the electric machine can be used.

The rotor 4 is then assembled. For this purpose, the at least one magnetic element 5 is arranged in the sleeve 16, and the one or more cavities formed by means of the sleeve 16 between the respective magnetic element and the inside of the sleeve 16 is optionally additionally at least partially filled with the filling material described above. Here, the at least one magnetic element 5 is arranged in such a way in the sleeve 16 that the respective cavity lies on the G axis of the electric machine. If, as described above with reference to FIG. 1, the rotor 4 furthermore has a continuous connecting rod 20, at least one additional support plate 18 and/or at least one elastic compensating element 17, in particular an elastic compensating or connecting layer, then assembly of the rotor 4 is accordingly carried out with this or these additional further components. As explained above with reference to FIG. 1, the connecting rod and the additional support plate as well as the compensating elements, in particular the elastic compensating or connecting layer, and the filling material 35 are composed of a nonmagnetic material.

After the connection of all the components of the rotor 4, including any of the abovementioned additional components of the rotor 4, the entire rotor 4 can be magnetized. The entire rotor 4 is then installed in the electric machine 1. In this case, it should preferably be ensured that a magnetic return path around the rotor 4 is ensured in a continuous way, e.g. by means of a special magnetization device or an assembly device mentioned below, e.g. an assembly ring, especially if the magnetic element is produced from an AlNiCo alloy.

The final assembly of the electric machine 1 takes place, for example, on an assembly device which prevents demagnetization of the rotor 4 and of its sleeve 16 produced from an anisotropic material, more precisely a sleeve 16 composed of the abovementioned AlNiCo alloy, in particular demagnetization of the active region of the anisotropic sleeve 16. In the fully assembled rotor 4, the at least one magnetic element 5 is arranged in the active region of the sleeve 16. Here, the active region is shown in the illustrative embodiment in FIG. 4 below. The regions of the sleeve 16 which project beyond the magnetic elements 5 or in which the magnetic elements 5 are not arranged, as shown in FIG. 4 below, each in turn form the passive region of the sleeve 16.

As an assembly device it is possible, for example, to use a ferromagnetic assembly ring (not illustrated) which, during the assembly of the electric machine 1, ensures that the magnetic circuit of the previously magnetized rotor 4 remains continuously closed during assembly and the sleeve 16 is not unintentionally demagnetized.

If, on the other hand, the magnetic circuit of the rotor 4 were open and not closed, there would be unintentional demagnetization of the sleeve 16 of the rotor 4, even before installation in the electric machine. The at least one magnetic element 5, which is produced from the above-described AlNiCo alloy, for example, is therefore first of all provided or mounted in the sleeve 16 together with the optionally present connecting rod, the optionally present at least one additional support plate, the optionally present filling material and/or the optionally present at least one compensating element.

In this case, the assembly ring (not illustrated) is slipped onto the outside of the sleeve 16 before, during or after the installation of the at least one magnetic element 5 and of the optionally present further components mentioned above, i.e. the connecting rod, support plate(s), compensating element(s), and/or filling material, in the sleeve 16. As explained above, the connecting rod, support plate(s), compensating element(s), in particular the compensating or connecting layer, and the filling material are nonmagnetic, that is to say produced from a nonmagnetic material.

The sleeve 16, provided with the assembly ring, of the previously magnetized rotor together with the abovementioned components provided in the sleeve 16 is then arranged within the stator 2 of the electric machine 1. Here, the assembly ring has the advantage that, during the assembly of the previously magnetized rotor 4, it ensures that the magnetic circuit of the rotor 4 is always closed and therefore unintentional demagnetization of the sleeve 16 cannot occur.

After the arrangement of the sleeve 16 in the stator 2, the assembly ring can be removed, and the sleeve 16 can then be connected to the two shaft parts of the two-part shaft of the electric machine 1.

After assembly, the at least one magnetic element 5 composed of the AlNiCo alloy arranged in the sleeve 16 can become completely or at least almost completely demagnetized since the magnetic circuit is now open and accordingly no longer closed. In this case, the magnetic circuit automatically remains open or is not closed since the two shaft ends of the electric machine and the optionally present support plate(s) and/or the optionally present compensating element(s) and/or optionally present filling material are each produced from a nonmagnetic material, as described above. Thus, the demagnetization of the at least one magnetic element 5 in the sleeve 16 takes place automatically by virtue of the two shaft ends and the support plate(s) optionally arranged therebetween and/or the compensating element(s) optionally arranged therebetween and/or the optionally provided filling material.

The rotor 4 according to the invention and accordingly the electric machine 1 having the rotor construction according to the invention can furthermore be produced as follows in accordance with the second example.

In this alternative illustrative embodiment, the sleeve 16 is likewise produced from a magnetically anisotropic material, e.g. the abovementioned AlNiCo alloy, and mounted on the rotor 4. Here, the axis of the magnetic anisotropy of the sleeve 16 preferably extends in the direction or substantially in the direction of the abovementioned D axis of the electric machine 1.

During the mounting of the sleeve 16 on the rotor 4, the at least one magnetic element 5 as well as the optionally present continuous connecting rod, the optionally present support plate(s), the optionally present compensating element(s) and/or the optionally present filling material are provided in the sleeve 16. To secure the rotor 4 on the electric machine 1, the sleeve 16 is connected to the two shaft parts of the electric machine 1, as described above by way of example with reference to FIG. 1.

After this, the entire rotor 4 can then be subjected to an additional suitable chemical treatment and/or thermal treatment to intensify the magnetic anisotropy of the sleeve 16. Each of the hard-magnetic materials can be demagnetized if its temperature is increased. Rare earth materials can be demagnetized at low temperatures of about 220° C., for example, and AlNiCo alloys can be demagnetized at 600-700° C., for example. A thermal treatment or suitable heating can then be carried out locally, for example, or in a desired region of the rotor 4, e.g. the active region thereof, preferably only along the Q axis of the electric machine 1. In this way it is possible to intensify the anisotropy. Here, the local heating can be achieved by means of one or more corresponding eddy current inductors, for example.

In this case, the magnetic anisotropy is intensified by the chemical and/or thermal treatment, particularly in the active region of the sleeve 16. The entire rotor 4, that is to say especially the sleeve 16 and the at least one magnetic element 5 arranged therein, is then re-magnetized. As described above, the sleeve 16 and the at least one magnetic element 5 accommodated therein as components of the rotor 4 are produced from a magnetically anisotropic material, e.g. an AlNiCo alloy. Such components of the rotor 4 composed of an AlNiCo alloy have very many advantages. Permanent magnets composed of the above-described AlNiCo alloy have a high magnetic remanence and high magnetic stability in relation to temperature influences of, for example, up to 500° C. and have a high remanence.

Such magnetic elements 5 composed of an AlNiCo alloy can be produced by means of different methods, e.g. by means of a casting method, e.g. precision casting or sand casting, or of a sintering method. However, the invention is not restricted to the stated methods for the production of a respective magnetically anisotropic magnetic element composed of a magnetically anisotropic material, in particular an AlNiCo alloy. Any other method or any other combination of methods can be provided which is/are suitable for the production of the respective magnetically anisotropic magnetic element of the rotor according to the invention.

Such magnetic elements can be produced by casting, wherein, for this purpose, a feed material composed of an AlNiCo alloy is melted, for example, and then poured into a sand casting mold or precision casting mold to form the magnetic element 5 of the rotor according to the invention.

In the sintering method, at least one rare earth material or a plurality of rare earth materials as the starting material is/are first of all pulverized. In the case of a plurality of pulverized rare earth materials, the powders are mixed with one another and then compressed to form a final compact. After this, the compact is sintered under a protective gas or in a vacuum at a temperature of about 1300° C., for example. Depending on the compaction density and sintering temperature, a sintering shrinkage of about 10%, for example, is possible during this process. By means of a subsequent heat treatment, it is possible to further correct the component structure of the finished magnetic element 5. Subsequent further processing of the magnetic element 5 obtained from the compact is possible, e.g. machining etc.

The properties of magnetically anisotropic magnetic elements 5 of this kind are used to produce the desired magnetic anisotropy by means of selective thermal treatment, e.g. in the region of the N pole and S pole of winding segments of the components of the two-pole rotor which are produced from an AlNiCo alloy.

FIGS. 3 and 4 show another illustrative embodiment of a basic arrangement of electromagnetically active components of the rotor 4 according to the invention. Here, FIG. 3 shows a sectional view from the side of the electric machine and of its rotor 4 according to the invention, and FIG. 4 shows a sectional view through the active region 30 of the rotor 4 shown in FIG. 3.

Here, the embodiment of the electric machine 1 and of the rotor 4 thereof in FIGS. 3 and 4 has substantially the same construction as the electric machine and the rotor thereof in FIGS. 1 and 2, and therefore reference is made in this respect to the description in FIGS. 1 and 2 in order to avoid unnecessary repetitions.

The embodiment of the electric machine 1 and of the rotor 4 thereof in FIGS. 3 and 4 furthermore differs from the illustrative embodiment shown in FIGS. 1 and 2 in that the electric machine 1 does not have a continuous connecting rod, as in FIGS. 1 and 2. Accordingly, the at least one magnetically anisotropic magnetic element 5 accommodated in the magnetically anisotropic sleeve 16 of the rotor 4 can be designed as a solid magnetic profile, e.g. as a cylinder with two flattened sections or flats 34 on the outside, as shown in FIGS. 3 and 4, to form a respective cavity 33 with the inside of the sleeve 16. As described above, the respective cavity 33 can be filled with air or at least partially with the additional filling material 35 described above. Furthermore, the cavities 33 are preferably formed in such a way that they lie on the Q axis 29 of the electric machine 1.

As described above with reference to FIGS. 1 and 2, one or more magnetically anisotropic magnetic elements 5 can be arranged in the magnetically anisotropic sleeve 16, said elements being respectively in the form of magnetic bars arranged radially around the rotational axis 21 of the rotor 4 and/or in the form of a magnetic sleeve or disk arranged in the axial direction of the sleeve 16, and/or in the form of a solid magnetic profile likewise arranged in the axial direction of the sleeve 16, as indicated for a cylindrical solid magnetic profile in FIGS. 3 and 4. The active region 30 and the two passive regions 31 of the rotor 4 are indicated in FIG. 3, as are the two shaft parts 12, 13 of the two-part shaft 6 of the electric machine which are connected to the sleeve 16.

Here, as in FIGS. 1 and 2 above, the direction of the anisotropy axis of the magnetically anisotropic sleeve 16 coincides with or as far as possible with the N-S (north pole-south pole) axis, i.e. the D axis 28, of the electric machine 1, for example. The “Q axis” 29 of the electric machine 1 extends perpendicularly to the N-S axis or D axis 28, as shown in FIG. 2.

As described above with reference to FIGS. 1 and 2, the magnetic elements 5 arranged in the sleeve 16 can be magnetized radially and/or diametrically. This applies to all the embodiments of the invention.

As shown in FIG. 3, the sleeve 16, as in FIG. 1 above, has an offset on the inside thereof, for example, up to which the magnetic element 5 shown in FIGS. 3 and 4 can be introduced. The sleeve 16 can likewise also be provided with a constant diameter or, as an alternative, with a depression, e.g. groove 32, on its inside or inner circumference, as indicated by a dashed line in FIG. 3. In this case, as explained above with reference to FIG. 1, a segmented construction of the magnetic elements 5 to be accommodated in the sleeve 16 and, where applicable, at least one support plate are required.

In this case, as described above with reference to FIG. 1, it is optionally furthermore possible in addition to provide the additional support plate (not illustrated) composed of a nonmagnetic material, e.g. steel or a fiber composite material, at at least one end of the magnetic element 5 in FIG. 3.

In the illustrative embodiment shown in FIGS. 3 and 4, the compensating element 17 described above with reference to FIG. 1, in this case a compensating or connecting layer, is furthermore additionally provided at both ends of the magnetic element 5, for example. As described above with reference to FIG. 1, the compensating or connecting layer as the compensating element 17 is composed of nonmagnetic and preferably electrically nonconductive material, e.g. a resin, which is at least still partially elastic after curing. The same material can be used as a material for the compensating or connecting layer as that for the filling material or a different material from the filling material can be used.

The compensating or connecting layer as the compensating element 17 has elastic and damping properties and ensures equalization of forces or uniform distribution of the preloading forces from the sleeve to the magnetic elements in the radial direction in order to absorb centrifugal forces. As explained above, the material of this layer is preferably electrically nonconductive.

According to the invention, as described above, examples of suitable methods for the production of such a rotor 4, excited by a permanent magnet, for the electric machine 1, e.g. a high-speed electric machine, and the sequence of the assembly thereof are also provided.

By virtue of the elastic properties of the compensating or connecting layer, this structure shown in FIGS. 3 and 4 also forms a tolerance compensator between the high-tolerance metallic elements, i.e. the two shaft parts 12, 13 of the two-part shaft 6 and the sleeve 16, and the at least one magnetic element 5. Either the manufacture thereof does not allow precise tolerances or the subsequent processes, e.g. grinding, are very expensive or, in some circumstances, even injurious to health or a risk to the environment. As a result, the centrifugal forces of the respective magnetic elements 5 in the sleeve 16 are neutralized or suitably compensated within a wide operating range of the rotational speed and temperature, in particular operating temperature, of the electric machine 1.

A flow diagram relating to the production of the rotors 4 according to the invention described above by way of example with reference to FIGS. 1 to 4 is illustrated in FIG. 5.

To produce the respective rotor, the magnetically anisotropic sleeve for accommodating the at least one magnetically anisotropic magnetic element is provided in a first step S1. Here, the magnetically anisotropic magnetic element is designed in such a way that, at least in one section on the outside thereof, it forms with the inside of the sleeve a cavity which can be at least partially filled with air and/or an additional filling material.

In this case, it is optionally possible for the sleeve to be provided on its inner circumference or for the respective magnetic element to be provided on its outer circumference with the compensating element, in particular the compensating or connecting layer, before the magnetic element is then introduced into the sleeve.

In a subsequent step S2, the at least one magnetic element is introduced into the sleeve, a process in which the first of two support plates can optionally be introduced in advance into the sleeve, before the at least one magnetic element is then inserted into the sleeve.

The at least one cavity formed by the respective magnetic element and the sleeve can furthermore additionally be at least partially or completely filled with a filling material, wherein the same material as or a different material from that for the compensating or connecting layer described above with reference to FIGS. 1-4 can be used as the filling material. Here, the filling material is nonmagnetic and preferably additionally elastic, as described above. As a particular preference, the filling material is furthermore thermally conductive.

Here, it is possible, in principle, to use the same material, e.g. a resin, as a filling material as for the elastic compensating and connecting layer described above with reference to FIG. 1, or to use some other material, e.g. a fiber composite material, such as a carbon fiber composite material, plastic etc.

In a further step S3, the support plates and/or compensating elements, where provided, in particular in the form of a compensating or connecting layer, are arranged at the outer ends of the magnet arrangement. If one of the support plates has already been positioned in the sleeve, only the second, remaining, support plate is likewise arranged in the sleeve.

If provided, the connecting rod can, following step S2, be inserted into the leadthrough formed by the at least one magnetic element and, if already inserted, can be passed through the opening of the support plates. It is likewise possible, only after step S3, in a step S3*, for the connecting rod to be passed through the opening of the support plates and the leadthrough of the at least one magnetic element.

The sleeve can be provided on its outside with the additional assembly ring, for example, as explained above. In this case, the assembly ring can be mounted on the sleeve before or after one of steps S1, S2, S3 or S3*.

In a subsequent step S4, the sleeve can first of all be arranged in the stator of the electric machine, and the two shaft parts can then be secured by their inner ends in the associated ends of the sleeve or vice versa. In this case, the optionally present assembly sleeve is removed after the sleeve has been arranged in the stator.

If no assembly sleeve is used, it is possible, after the assembly of the rotor, e.g. following step S3, S3* or S4, for an optional additional chemical treatment and/or thermal treatment of the rotor to take place in order to intensify the magnetic anisotropy of the rotor in the active region thereof. In a subsequent step S4*, re-magnetization of the entire rotor and connection of the rotor to the two shaft parts takes place in step S4 in this case.

Although the present invention has been fully described above by means of preferred illustrative embodiments, it is not restricted thereto but can be modified in many different ways. In particular, the illustrative embodiments described above with reference to FIGS. 1 to 5, in particular individual features thereof, can also be combined with one another.

1. A rotor (4) for an electric machine (1), the rotor having:
at least one magnetic element (5); and
a magnetically anisotropic sleeve (16) for receiving the at least one magnetic element (5).

2. The rotor as claimed in claim 1, characterized in that an axis of magnetic anisotropy of the sleeve (16) extends in the same direction or substantially in the same direction as a D axis (28) of an electric machine (1) in which the rotor (4) is provided.

3. The rotor as claimed in claim 1, characterized in that the at least one magnetic element (5) forms, on an outside of the magnetic element (5), in at least one section, with an inside of the sleeve, a cavity (33) filled with air and/or a filling material (35).

4. The rotor as claimed in claim 1, characterized in that at least one magnetic element (5) is a permanent magnet.

5. The rotor as claimed in claim 1, characterized in that the at least one magnetic element (5) is a magnetic bar, a magnetic sleeve, a magnetic disk with or without a through opening or a solid magnetic profile.

6. The rotor as claimed in claim 1, characterized in that the at least one magnetic element (5) is configured to be magnetized radially or diametrically.

7. The rotor as claimed in claim 1, characterized in that the sleeve (16) has a constant inside diameter throughout, a groove (32) or an offset to receive the at least one magnetic element (5).

8. The rotor as claimed in claim 1, characterized in that an at least partially elastic and nonmagnetic compensating element (17) is provided on an inner circumferential surface of the sleeve (16), on an outer circumferential surface of the at least one magnetic element (5) and/or at at least one end of the at least one magnetic element (5).

9. The rotor as claimed in claim 1, characterized in that a nonmagnetic support plate (18) is provided in the sleeve (16) at one or both ends of the at least one magnetic element (5), wherein the nonmagnetic support plate (18) forms an axial receptacle for the at least one magnetic element (5).

10. The rotor as claimed in claim 1, characterized in that the sleeve (16) is configured to be connected at least to one end of a shaft part (12, 13) of the electric machine (1).

11. The rotor as claimed in claim 1, characterized in that the sleeve (16) and/or the at least one magnetic element (5) is/are treated by a chemical process and/or a thermal process to increase the magnetic anisotropy, at least in one section.

12. An electric machine (1) having a a rotor (4) as claimed in claim 1, wherein the electric machine (1) also has a stator (2), which is arranged around the rotor (4).

13. The electric machine (1) as claimed in claim 12, characterized in that the electric machine (1) has a shaft (6) that is divided into two and has first and second shaft parts (12, 13), wherein the rotor (4) is arranged between the first and second shaft parts (12, 13).

14. The electric machine (1) as claimed in claim 12, characterized in that the electric machine (1) has first and second impellers (8, 9) and a connecting rod (20), which is passed through a leadthrough of the rotor (4) and through leadthroughs of the first and second shaft parts (12, 13), wherein the first and second impellers (8, 9) are arranged at the ends of the connecting rod (20), opposite the respectively associated first and second shaft parts (12, 13), and the shaft parts with the rotor are clamped to one another.

15. A method for producing a a magnetically anisotropic rotor for an electric machine as claimed in claim 1, wherein the method has the following steps:
providing the magnetically anisotropic sleeve (16) and the at least one magnetic element (5); and
inserting the at least one magnetic element (5) into the sleeve (16).

16. The method as claimed in claim 15, characterized in that the at least one magnetic element (5) forms, on an outside of the magnetic element (5), in at least one section, with an inside of the sleeve, a cavity (33) filled with air and/or a filling material.

17. The method as claimed in claim 15, further comprising arranging a nonmagnetic support plate (18) in the sleeve (16) at at least one end of the at least one magnetic element (5) to form an axial receptacle for the at least one magnetic element (5).

18. The method as claimed in claim 15, further comprising providing a compensating element (17) between the outside of the at least one magnetic element (5) and the inside of the sleeve (16) and/or at at least one end of the at least one magnetic element (5).

19. The method as claimed in claim 15, further comprising arranging an assembly sleeve on the outside of the magnetically anisotropic sleeve (16) and arranging the magnetically anisotropic sleeve (16) in the stator (2) of the electric machine and subsequent removal of the assembly sleeve.

20. The method as claimed in claim 15, further comprising carrying out a chemical treatment and/or thermal treatment after the assembly of the rotor in order to intensify the magnetic anisotropy of the rotor in the active region thereof, and connecting the rotor to the two shaft parts of the two-part shaft of the electric machine.

21. The rotor as claimed in claim 1, characterized in that the at least one magnetic element (5) forms, on an outside of the magnetic element (5), in at least one section, with an inside of the sleeve, a cavity (33) filled with air and/or a filling material (35), and wherein the filling material is a nonmagnetic and electrically nonconductive material.

22. The rotor as claimed in claim 1, characterized in that at least one magnetic element (5) is a magnetically anisotropic magnetic element, wherein the magnetically anisotropic magnetic element is produced from an FeNi alloy or an AlNiCo alloy.

23. The rotor as claimed in claim 1, characterized in that an at least partially elastic and nonmagnetic compensating element (17) is provided on an inner circumferential surface of the sleeve (16), on an outer circumferential surface of the at least one magnetic element (5) and/or at at least one end of the at least one magnetic element (5), wherein the compensating element (17) is an at least partially elastic and nonmagnetic compensating layer which is composed of a resin, fiber composite material and/or plastic, which is at least partially elastic after curing.

24. The rotor as claimed in claim 1, characterized in that the sleeve (16) is configured to be connected at least to one end of a shaft part (12, 13) of the electric machine (1) by shrink-fitting or press-fitting onto the shaft part (12, 13).

25. The rotor as claimed in claim 1, characterized in that the sleeve (16) and/or the at least one magnetic element (5) is/are treated by a chemical process and/or a thermal process to increase the magnetic anisotropy, at least in one section, in the vicinity of a magnetic pole.

26. The electric machine (1) as claimed in claim 12, characterized in that the electric machine (1) has a shaft (6) that is divided into two and has first and second shaft parts (12, 13), wherein the rotor (4) is arranged between the first and second shaft parts (12, 13) and is connected, in a fixed manner, to the first and second shaft parts (12, 13).

27. The electric machine (1) as claimed in claim 12, characterized in that the electric machine (1) has first and second impellers (8, 9) and a connecting rod (20), which is passed through a leadthrough of the rotor (4) and through leadthroughs of the first and second shaft parts (12, 13), wherein the first and second impellers (8, 9) are arranged at ends of the connecting rod (20), opposite the respectively associated first and second shaft parts (12, 13), and the shaft parts with the rotor are clamped to one another by clamping elements.

28. The method as claimed in claim 15, characterized in that the at least one magnetic element (5) forms, on an outside of the magnetic element (5), in at least one section, with an inside of the sleeve, a cavity (33) filled with air and/or a filling material, and wherein the filling material is a nonmagnetic and electrically nonconductive material.

28. The method as claimed in claim 15, further comprising providing a compensating element (17) between the outside of the at least one magnetic element (5) and the inside of the sleeve (16) and/or at at least one end of the at least one magnetic element (5), wherein the compensating element is a liquid resin, which is at least partially elastic after curing in the sleeve.

29. The method as claimed in claim 15, further comprising arranging a ferromagnetic assembly sleeve on the outside of the magnetically anisotropic sleeve (16) and arranging the magnetically anisotropic sleeve (16) in the stator (2) of the electric machine and subsequent removal of the assembly sleeve.
